(19) United States
(12) Patent Application Publication
(10) Pub. No.: US 2024/0158631 A1
(43) Pub. Date: May 16, 2024

(54) HIGH STRENGTH FLAME RETARDANT POLYESTER MATERIAL

(71) Applicant: NAN YA PLASTICS CORPORATION, TAIPEI (TW)

(72) Inventors: Te-Chao Liao, TAIPEI (TW); Chun-Che Tsao, TAIPEI (TW); Wen-Jui Cheng, TAIPEI (TW); Yueh-Shin Liu, TAIPEI (TW)

(73) Assignee: NAN YA PLASTICS CORPORATION, TAIPEI (TW)

(21) Appl. No.: 18/084,566

(22) Filed: Dec. 20, 2022

(30) Foreign Application Priority Data
Nov. 11, 2022 (TW) 111143210

(51) Int. Cl. C08L 67/03; C08K 3/016; C08K 9/06; C08L 33/12

(52) U.S. Cl. CPC C08L 67/03; C08K 3/016; C08K 9/06; C08L 33/12; C08L 2201/02; C08L 2201/22; C08L 2205/16

(57) ABSTRACT

The invention provides a high strength flame-retardant polyester material, which includes a PET resin, a nucleating agent, a flame retardant, an antioxidant, a rod-shaped filling and reinforcing material and a compatibilizer. The PET resin includes virgin pellets or environmentally-friendly recycled pellets, which can meet the demand for the introduction of recycled materials.

### CROSS-REFERENCE TO RELATED APPLICATION

This application claims the priority benefit of Taiwan application serial no. 111143210, filed on Nov. 11, 2022. The entirety of the above-mentioned patent application is hereby incorporated by reference herein and made a part of this specification.

### BACKGROUND

### Technical Field

The disclosure relates to a polyester material, and particularly relates to a high strength flame-retardant polyester material.

### Description of Related Art

In the future, the market will gradually lead to the trend of circular economy, energy saving and carbon reduction. Under this market trend, the introduction of products with low-carbon recycled materials is an important goal of future industrial development. The introduction of recycled materials is based on the premise that the mechanical properties and processability are not affected, and the introduction of environmentally friendly recycled materials will help achieve the goal of reducing plastic and energy saving globally.

PET polyester material is the material with the most complete recycling industry chain among plastic materials, and its recycling sources include: plastic bottles, release films, industrial films, fabrics, etc. Through solid-state polymerization and chain extension modification, the mechanical properties of recycled PET can be equivalent to virgin PET. However, its strength, rigidity, and flame retardancy cannot meet the needs of industrial connectors, fans, sports equipment and other products.

Based on above, developing a high-strength flame-retardant polyester material which effectively improves strength, rigidity, and flame retardancy is a target that are those skilled in the art eager to achieve.

### SUMMARY

The disclosure provides a high strength flame-retardant polyester material, which can effectively improve strength, rigidity, and flame retardancy.

A high strength flame-retardant polyester material according to the disclosure includes a PET resin, a nucleating agent, a flame retardant, an antioxidant, a rod-shaped filling and reinforcing material, and a compatibilizer.

In an embodiment of the disclosure, based on a total weight of the high strength flame-retardant polyester material, an added amount of the PET resin is 45 wt % to 62 wt %, an added amount of the nucleating agent is 0.5 wt % to 3 wt %, an added amount of the flame retardant is 10 wt % to 18 wt %, an added amount of the antioxidant is 0.1 wt % to 1 wt %, an added amount of the rod-shaped filling and reinforcing material is 25 wt % to 32 wt %, and an added amount of the compatibilizer is 2 wt % to 5 wt %.

In an embodiment of the disclosure, the PET resin includes virgin pellets or environmentally-friendly recycled pellets. A source of the environmentally-friendly recycled pellets may include recycled pellets for bottles, film materials, fabrics, or industrial recycled environmental-friendly polyester pellets (release film, etc.).

In an embodiment of the disclosure, an inherent viscosity (I.V.) of the PET resin is 0.6 to 0.9.

In an embodiment of the disclosure, the nucleating agent comprises an organic nucleating agent, an inorganic nucleating agent or a blend thereof.

In an embodiment of the disclosure, the organic nucleating agent comprises organic sodium salts, the organic sodium salts comprise sodium benzoate, sodium montanite or ethylene-methacrylic acid copolymer (EMAA).

In an embodiment of the disclosure, the inorganic nucleating agent comprises inorganic micro-nano powders, the inorganic micro-nano powders comprise talc, titanium dioxide, silica or calcium carbonate.

In an embodiment of the disclosure, the flame retardant is a halogen free flame retardant, the halogen free flame retardant comprises nitrogen flame retardant, phosphorus flame retardant or composite blends thereof.

In an embodiment of the disclosure, the antioxidant comprises a hindered phenol antioxidant, a phenol antioxidant, a hybrid antioxidant, a phosphite antioxidant, a compound antioxidant or a combination thereof.

In an embodiment of the disclosure, the rod-shaped filling and reinforcing material comprises siloxane-modified glass fibers.

In an embodiment of the disclosure, the compatibilizer comprises ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof.

Based on the above, the disclosure provides a high strength flame-retardant polyester material, which improves a flame retardancy of PET materials through phosphorus-based and nitrogen-based flame retardants, so as to achieve halogen-free and non-toxic flame retardant products. Through a mixing and modification technology, problems of slow crystallization rate, insufficient impact strength and rigidity of PET materials can be improved, so that it can be injected molding and used in the products such as industrial connectors, fans, sports equipment, battery and electrical housings, etc. In addition, the PET material used in the disclosure can also be environmental-friendly recycled PET (PCR-PET) in addition to PET virgin resin, and its mechanical properties, flame retardant properties and fluidity are equivalent to virgin resin. Therefore, the requirement of importing recycled materials can be achieved.

### DESCRIPTION OF THE EMBODIMENTS

Hereinafter, embodiments of the disclosure will be described in detail. However, these embodiments are illustrative, and the disclosure is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification.

A high strength flame-retardant polyester material according to the disclosure includes a PET resin, a nucleating agent, a flame retardant, an antioxidant, a rod-shaped filling and reinforcing material, and a compatibilizer. Hereinafter, the above-mentioned components will be described in detail.

PET Resin

In the present embodiment, a PET resin may include virgin pellets or environmental-friendly recycled pellets, wherein a source of the environmental-friendly recycled pellets may include recycled pellets for bottles, film materials, fabrics, or industrial recycled environmental-friendly polyester pellets (release film, etc.), so as to achieve the requirement of importing recycled materials. However, the disclosure is not limited thereto. An inherent viscosity of the PET resin is 0.60 to 0.90, for example, preferably 0.70 to 0.84, for example. Based on a total weight of the high strength flame-retardant polyester material, an added amount of the PET resin is 45 wt % to 62 wt %, for example.

Nucleating Agent

In the present embodiment, a nucleating agent may include an organic nucleating agent, an inorganic nucleating agent or a blend thereof. The organic nucleating agent may include organic sodium salts, and the organic sodium salts may include sodium benzoate, sodium montanite or ethylene-methacrylic acid copolymer (EMAA). The inorganic nucleating agent may include inorganic micro-nano powders, and the inorganic micro-nano powders may include talc, titanium dioxide, silica or calcium carbonate. Based on a total weight of the high strength flame-retardant polyester material, an added amount of the crystal nucleating agent is 0.5 wt % to 3 wt %. Preferably, for example, an organic crystal nucleating agent plus an inorganic crystal nucleating agent is used for compounding. In this case, based on the total weight of the high strength flame-retardant polyester material, the added amount is, for example, 1 wt % to 2 wt %, wherein a weight ratio of the organic crystal nucleating agent to the inorganic crystal nucleating agent is, for example, 2:1 to 1:1. Adding the crystal nucleating agent can increase the crystallization and solidification rate of the PET material, thereby improving its processability.

Flame Retardant

In the present embodiment, in order to meet the requirement of RoHS and halogen free for product, a flame retardant is a halogen free flame retardant. The halogen free flame retardant may include a nitrogen flame retardant, a phosphorus flame retardant or composite blends thereof. The phosphorus flame retardant may include pentaerythritol bisphosphate melamine salt (MPP), ammonium polyphosphate (APP), toluene xylyl phosphate or hypophosphite. The nitrogen flame retardant may include melamine cyanurate (MCA), melamine, etc. More particularly, the compound effect of hypophosphite and melamine cyanurate (MCA) is better, and the weight ratio of hypophosphite to melamine cyanurate (MCA) is 3:1 to 1:1. Based on a total weight of the high strength flame-retardant polyester material, an added amount of the flame retardant is 10 wt % to 18 wt %, for example, preferably, 12 wt % to 15 wt %, for example. The flame retardant can inhibit the combustion of PET through carbonization on the surface and improve the flame retardant properties.

Antioxidant

In the present embodiment, an antioxidant may include a hindered phenol antioxidant, a phenol antioxidant, a hybrid antioxidant, a phosphite antioxidant, a compound antioxidant or a combination thereof. Based on a total weight of the high strength flame-retardant polyester material, an added amount of the antioxidant is 0.1 wt % to 1 wt %, for example. The antioxidant can improve the heat resistance and processability of the material.

Rod-Shaped Filling and Reinforcing Material

In the present embodiment, a rod-shaped filling and reinforcing material may include siloxane-modified glass fibers. The surface is modified with siloxane to improve the compatibility. A diameter of the glass fiber is 10 μm to 13 μm, and a length of a cut strand is 3 mm to 4 mm, for example. Based on a total weight of the high strength flame-retardant polyester material, an added amount of the rod-shaped filling and reinforcing material is 25 wt % to 32 wt %, for example. The rod-shaped filling and reinforcing material can effectively improve the impact strength and rigidity of the material, and the improvement effect of physical properties is directly related to the dispersion degree of the rod-shaped reinforcing material. Therefore, it is necessary to simultaneously introduce a compatibilizer grafted with GMA to improve the rod-shaped filling and reinforcing material dispersibility in PET.

Compatibilizer

In the present embodiment, a compatibilizer may include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof. Based on a total weight of the high strength flame-retardant polyester material, an added amount of the compatibilizer is 2 wt % to 5 wt %, for example. Based on a weight of the rod-shaped filling and reinforcing material, an added amount of the compatibilizer is 10 wt % to 20 wt %, for example. The compatibilizer can improve the compatibility between rod-shaped filling and reinforcing material and PET resin to improve the material reinforcement effect.

A reforming process of high strength flame-retardant polyester material in the disclosure includes the following steps. First, the PET resin, the nucleating agent, the antioxidant and the compatibilizer are added to the extruder at the main feed temperature of 230° C. to 250° C. After that, the flame retardant is added to the extruder at a feed temperature of 250° C. to 270° C. Next, the rod-shaped filling and reinforcing material is added into the extruder at a feed temperature of 255° C. to 275° C. Finally, the high strength flame-retardant polyester material of the disclosure can be produced by vacuuming at a temperature of 245° C. to 265° C.

Below, the above-mentioned high strength flame-retardant polyester material of the disclosure is described in detail by experimental example. However, the following experimental examples are not intended to limit the disclosure.

### Experimental Examples

In order to prove that the flame-retardant polyester material proposed by the disclosure has excellent mechanical properties, and can further have good flame retardant and heat-resistant properties, this experimental example is specially performed below.

Test Methods

Specific gravity: ASTM D792

Tensile strength, elongation: ASTM D638

Bending strength, bending modulus: ASTM D790

Flame retardant: UL94

Material Property Evaluation

PBT+30% GF for industrial parts, an unmodified PET, PET+30% GF for recycled material, and flame-retardant polyester material of the disclosure are tested by the above test methods, and the test results are listed in Table 1 below. In Table 1, the flame-retardant polyester material of the disclosure includes 49.5 wt % PET resin, 2.0 wt % crystal nucleating agent, 15.0 wt % flame retardant, 0.5 wt % antioxidant, 30.0 wt % rod-shaped filling and reinforcing material and 3.0 wt % compatibilizer.

As shown in Table 1, the impact resistance, rigidity (flexural modulus), and flame retardancy of unmodified PET materials cannot meet the product needs of the industrial parts. Although PET+30% GF for recycled material can meet the requirements of mechanical properties, it has no flame retardant effect. In contrast, the flame-retardant polyester material of the disclosure has the same flame-retardant and heat-resistant characteristics as PBT+30% GF for industrial parts, and also has good mechanical properties.

TABLE 1

| | | PBT + 30% GF | | PET + 30% GF | flame-retardant |
|---|---|---|---|---|---|
| | | for industrial | Unmodified | for recycled | polyester material |
| | | parts | PET | material | of the disclosure |
| Mechanical | Specific gravity | 1.59 | 1.35 | 1.52 | 1.58 |
| properties | Impact strength | 8 | 3.5 | 8 | 7.5 |
| | (kg-cm/cm) | | | | |
| | Tensile strength | 110 | 60 | 135 | 100 |
| | (MPa) | | | | |
| | Elongation (%) | 3.5 | 5.2 | 3.2 | 3.2 |
| | Bending strength | 150 | 88 | 160 | 148 |
| | (MPa) | | | | |
| | Bending modulus | 8000 | 2400 | 8500 | 9000 |
| | (MPa) | | | | |
| Flame | UL94 flame | 1.5 mm V0 | HB | HB | 1.2 mm V0 |
| retardant | retardant | | | | |
| properties | | | | | |
| Heat | Heat distortion | 206 | 70 | 212 | 210 |
| Resistance | temperature | | | | |
| Properties | | | | | |

In summary, the high strength flame-retardant polyester material of the disclosure is modified by adding additives such as flame retardant, nucleating agent and rod-shaped filling and reinforcing material. Adding nucleating agent can increase the crystallization and solidification rate of PET material, thereby improving its processability. The flame retardant can inhibit the combustion of PET through carbonization on the surface and improve the flame retardant properties. The rod-shaped filling and reinforcing material can effectively improve the impact strength and rigidity of the material, wherein the effect of physical property improvement is directly related to the degree of dispersion of the rod-shaped reinforcing material. Therefore, it is necessary to simultaneously introduce a -GMA-grafted compatibilizer to improve the dispersion of the rod-shaped reinforcing material. The antioxidant can improve the heat resistance and processability of the material. In this way, the problems of slow crystallization rate and insufficient strength of PET material can be effectively improved, so that it can be applied to products such as industrial connectors, fans, sports equipment, and battery and electrical housings. Furthermore, in addition to PET virgin pellets, the PET materials used in the disclosure can also be imported into environmental-friendly recycled PET (PCR-PET), and the mechanical properties, flame retardant properties are equivalent to virgin pellets. As a result, the demand for the introduction of recycled materials can be achieved, and it is more in line with the trend of circular economy.

What is claimed is:

1. A flame-retardant polyester material, comprising:
a PET resin;
a nucleating agent;
a flame retardant;
an antioxidant;
a rod-shaped filling and reinforcing material; and
a compatibilizer.

2. The flame-retardant polyester material according to claim 1, wherein based on a total weight of the flame-retardant polyester material, an added amount of the PET resin is 45 wt % to 62 wt %, an added amount of the nucleating agent is 0.5 wt % to 3 wt %, an added amount of the flame retardant is 10 wt % to 18 wt %, an added amount of the antioxidant is 0.1 wt % to 1 wt %, an added amount of the rod-shaped filling and reinforcing material is 25 wt % to 32 wt %, and an added amount of the compatibilizer is 2 wt % to 5 wt %.

3. The flame-retardant polyester material according to claim 1, wherein the PET resin comprises virgin pellets or environmental-friendly recycled pellets.

4. The flame-retardant polyester material according to claim 1, wherein an inherent viscosity of the PET resin is 0.60 to 0.90.

5. The flame-retardant polyester material according to claim 1, wherein the nucleating agent comprises an organic nucleating agent, an inorganic nucleating agent or a blend thereof.

6. The flame-retardant polyester material according to claim 5, wherein the organic nucleating agent comprises organic sodium salts, the organic sodium salts comprise sodium benzoate, sodium montanite or ethylene-methacrylic acid copolymer (EMAA).

7. The flame-retardant polyester material according to claim 5, wherein the inorganic nucleating agent comprises inorganic micro-nano powders, the inorganic micro-nano powders comprise talc, titanium dioxide, silica or calcium carbonate.

8. The flame-retardant polyester material according to claim 1, wherein the flame retardant is a halogen free flame retardant, the halogen free flame retardant comprises nitrogen flame retardant, phosphorus flame retardant or composite blends thereof.

9. The flame-retardant polyester material according to claim 1, wherein the antioxidant comprises a hindered phenol antioxidant, a phenol antioxidant, a hybrid antioxidant, a phosphite antioxidant, a compound antioxidant or a combination thereof.

10. The flame-retardant polyester material according to claim 1, wherein the rod-shaped filling and reinforcing material comprises siloxane-modified glass fibers.

11. The flame-retardant polyester material according to claim 1, wherein the compatibilizer comprises ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof.
